(19) United States
(12) Patent Application Publication
(10) Pub. No.: US 2009/0047549 A1
(43) Pub. Date: Feb. 19, 2009

(54) MODIFIED CARBONIZED SUBSTRATE AND ITS MANUFACTURING METHOD AND USE

(75) Inventors: Tse-Hao Ko, Taichung (TW); Jui-Hsiang Lin, Taichung (TW); Jian-Jun Huang, Taichung (TW); Yuankai Liao, Taichung (TW); Ching-Han Liu, Taichung (TW); Chih-Jung Hung, Taichung (TW)

Correspondence Address: VENABLE LLP, P.O. BOX 34385, WASHINGTON, DC, 20043-9998, US

(73) Assignee: FENG CHIA UNIVERSITY

(21) Appl. No.: 11/965,145

(22) Filed: Dec. 27, 2007

(30) Foreign Application Priority Data
Aug. 15, 2007 (TW) 096130160

(51) Int. Cl. B05D 5/12; H01M 8/00

(52) U.S. Cl. 429/12; 427/115

(57) ABSTRACT

A process for modifying a carbonized substrate and a modified carbonized substrate obtained therefrom are provided. The process involves the application of a mixture containing a hydrophobic polymer and a carbonaceous material onto a carbonized substrate which is not subjected to a hydrophobic treatment. The subject invention uses a simpler procedure to modify a carbonized substrate to provide a modified carbonized substrate with good conductivity, air permeability, and hydrophobicity. The modified carbonized substrate is suitable for use as the material for the gas diffusion layer of the electrode in fuel cells.

This application claims priority to Taiwan Patent Application No. 096130160 filed on Aug. 15, 2007.

### CROSS-REFERENCES TO RELATED APPLICATIONS

Not applicable.

### BACKGROUND OF THE INVENTION

1. Field of the Invention

The present invention relates to a method for modifying a carbonized substrate, and particularly, to a method for modifying the gas diffusion layer that can be used as an electrode in a fuel cell. The invention also provides a modified carbonized substrate obtained therefrom and uses thereof.

2. Descriptions of the Related Art

In an effort to alleviate the shortage of energy and the greenhouse effect on Earth over recent years, more attention is being directed to the development of fuel cells equipped with a hydrogen supply system. The fuel cell not only prevents the environmental problems caused by disposable non-rechargeable batteries, but also eliminates the need of a time-consuming recharging procedure required for a conventional rechargeable battery. Furthermore, the emission of the fuel cell (e.g., water) is harmless to the environment.

Among various fuel cells, the proton exchange membrane fuel cells (PEMFCs) and direct methanol fuel cells (DMFCs), which can operate at low temperatures and output a high current density, have been widely used in power supply systems of vehicles, combined power generation systems and various 3C products (such as laptops and handsets).

For example, in a PEMFC, each of its individual cells is mainly comprised of a membrane-electrode assembly (MEA) and bipolar plates with a gas flow channel. An MEA generally consists of a proton exchange membrane (typically made of a polymer membrane, for use as an electrolyte), two catalyst layers disposed on both sides of the proton exchange membrane, and two gas diffusion layers (also known as “electrode gas diffusion layers”) disposed on the exterior surfaces of the two catalyst layers.

Currently, most of the PEMFCs and DMFCs employ a porous carbon paper or carbon cloth as the material of the electrode gas diffusion layer. In addition to allowing the reactant gases to flow therethrough and serving as a channel for electron migration, the gas diffusion layer also assists the water management in the fuel cell, so that water generated during the catalytic reaction can be drained smoothly. Otherwise, the consequent water flooding would obstruct the transmission of the gases, thus impacting the performance of the fuel cell. Therefore, the water management ability of the gas diffusion layer is one of the factors critical to the electrical performance of the fuel cell.

To prevent the performance degradation of the fuel cell due to water flooding, a hydrophobic treatment is typically performed on the carbon substrate of the gas diffusion layer, so that the excessive water may be readily drained away, thereby prolonging the service life of the fuel cell. Furthermore, since the carbon cloth and carbon paper currently used have rough surfaces which may affect the reaction and efficiency of the catalyst on the catalyst layers, a leveling treatment on such surfaces is typically needed in addition to the hydrophobic treatment.

As disclosed by Taniguchi et al in U.S. Pat. No. 6,083,638, a fibrous carbon substrate is first subjected to a hydrophobic treatment with a fluororesin, and is dried at a temperature of 360° C. Then, the dried carbon substrate is treated with both a hydrophobic polymer and a hydrophilic polymer to produce hydrophobic channels and hydrophilic channels on the carbon substrate.

Furthermore, as disclosed in U.S. Pat. No. 5,561,000, a piece of carbon cloth or carbon paper is first subjected to a hydrophobic treatment with polytetrafluoroethylene (PTFE). Then, the PTFE treated carbon cloth or carbon paper is coated with a layer of a PTFE and carbon mixture.

WO 00/54350 issued to Gorman et al. provides a technique which improves the technique disclosed in U.S. Pat. No. 5,561,000. According to this technique, the resulting carbon cloth or carbon paper produced in U.S. Pat. No. 5,561,000 is further treated to modify it into a hydrophilic structure.

U.S. Pat. No. 6,733,915 discloses a piece of porous carbon cloth or carbon paper used as the substrate, which is then immersed into a fluorinated polymer solution for a hydrophobic treatment. Subsequently, the immersed carbon substrate is coated with a layer of a mixture of a fluorinated polymer and carbon particles and then dried at a high temperature to obtain a modified carbon substrate.

U.S. Pat. No. 7,063,913 discloses a porous carbon substrate pre-treated with a hydrophobic polymer, which is then dried to obtain a hydrophobic carbon substrate. Then, the hydrophobic carbon substrate is coated with a layer of a fluorocarbon polymer and carbon particle mixture. The substrate is finally subjected to a heat treatment.

In short, in the prior art, to obtain a hydrophobic gas diffusion layer, a carbon substrate is typically subjected to a hydrophobic treatment to obtain a hydrophobic carbon substrate. Thereafter, a mixture of hydrophobic polymer and carbon particles is applied to the hydrophobic carbon substrate by means of coating, immersing, spraying or the like, and is then subjected to a heat treatment at high temperature to finally obtain a hydrophobic gas diffusion layer material containing carbon particles on the surfaces thereof.

However, the inventors of the subject application have found through research that a hydrophobic carbonized substrate can be provided using a relatively simpler process which results in a modified carbonized substrate with the desired conductivity, hydrophobic property, air permeability and levelness.

### SUMMARY OF THE INVENTION

One objective of the subject invention is to provide a method for modifying a carbonized substrate which comprises the following steps: providing a carbonized substrate; providing a mixture containing a hydrophobic polymer and a carbonaceous material; applying the mixture onto at least one surface of the carbonized substrate; and thermally treating the carbonized substrate under the protection of an inert gas.

Another objective of the subject invention is to provide a modified carbonized substrate, which comprises a carbonized substrate and a leveling layer substantially directly disposed on at least one surface of the carbonized substrate.

Yet a further objective of the subject invention is to provide a fuel cell comprising an anode and a cathode, wherein at least either the anode or the cathode comprises the modified carbonized substrate.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is an illustrative view of a structure of a modified carbonized substrate in accordance with the subject invention; and

FIG. 2 is an illustrative view of a structure of a membrane-electrode assembly of a single cell in a fuel cell in accordance with the subject invention.

### DESCRIPTION OF THE PREFERRED EMBODIMENT

The carbonized substrate used in the method for modifying a carbonized substrate of the subject invention can be selected from a group consisting of carbon cloth, carbon paper, and carbon felt. More specifically, any materials suitable for a gas diffusion layer of a fuel cell may be applied to the method of the subject invention. For example, TGP grade carbon paper from the Toray Company, CPW-003 carbon fabric from Textron USA, TCM 128 and TGM 389 carbon fabrics from Le Carboneloraine, Panex PW-03 from Zoltek Companies, Inc., Sigracet GDL 10AA from SGL, Technimat from Lydell, or Spectracarb from Spectracorp can be used. Alternatively, a carbonized substrate purchased in the market (e.g., Model FCW 1005 carbon cloth from CHALLENGE CARBON TECHNOLOGY CO., LTD.) or produced by a known method (e.g., the carbon fiber paper obtained by the method disclosed in U.S. Application Publication No. 2006/0214320) may be thermally treated at high a temperature to provide a carbonized substrate for use in the method of the subject invention.

In the method of the subject invention, a mixture containing a hydrophobic polymer and a carbonaceous material is applied directly onto at least one surface of the carbonized substrate to form a leveling layer thereon. Here, the hydrophobic polymer useful in the subject invention is typically a polymer containing a fluorine-carbon bond, which is believed to provide the desired hydrophobic property. For example, the hydrophobic polymer may be selected from a group consisting of polytetrafluoroethylene (PTEF), polyhexafluoropropylene (PHFP), copolymers of hexafluoropropylene and tetrafluoroethylene (FEP), copolymers of tetrafluoroethylene and perfluoropropylvinylether (PFA), copolymers of tetrafluoroethylene and perfluoromethylvinylether (MFA), homopolymers of chlorotrifluoroethylene (PCTFE), polyvinylidene fluoride (PVDF), poly(vinylfluoride) (PVF), copolymer of tetrafluoroethylene and ethylene (ETFT), copolymer of vinylidene fluoride and hexafluoropropylene and tetrafluoroethylene (THV), and combinations thereof. The hydrophobic polymer should preferably be selected from a group consisting of PTFE, FEP, PFA, and combinations thereof.

In accordance with the subject invention, the hydrophobic polymer is generally used in the solution form, e.g., in a dispersion form. For example, a hydrophobic polymer-containing dispersion obtained from the emulsion polymerization of a monomer may be directly used. Alternatively, the hydrophobic polymer powder, solvent and surfactant are mixed to provide a dispersion containing the hydrophobic polymer. Currently, some solution products containing the hydrophobic polymer are available in the market and may be directly used in the subject invention, for example, the T30 PTFE solution from Du Pont and NEOFLON FEP ND-20 from Daikin Industries Ltd.

In addition to the hydrophobic polymer, the mixture further comprises a carbonaceous material, which may render the leveling layer formed on the carbonized substrate conductive. Any carbonaceous material with appropriate forms may be applied to the subject invention, for example, a powdered carbonaceous material, a fibrous carbonaceous material, or a combination thereof. The carbonaceous material may be, for example (but is not limited to), carbon black, graphite, acetylene black, or a combination thereof. The following powdered carbonaceous materials may also be used: carbon black (e.g., Vuelcan® XC-72 from Cabot Corp., Vuelcan® XC-72R from Cabot Company, and N660 from Korea Steel Chemical Corp.), graphite (artificial graphite or natural graphite), acetylene black, or a combination thereof. Preferably, carbon black is used. The powdered carbonaceous material suitable for the subject invention generally has a particle size ranging from about 10 nm to about 200 nm, preferably from about 15 nm to about 170 nm, and more preferably from about 20 nm to about 150 nm. Additionally, when a fibrous carbonaceous material is used, staple carbon fibers with a length ranging from about 5 mm to about 200 mm are generally used. Depending on the actual requirements, the amount of the carbonaceous material ranges from about 1 wt % to about 90 wt %, and preferably from about 3 wt % to about 20 wt % based on the total weight of the hydrophobic polymer and the carbonaceous material. In one embodiment of the subject invention, the carbonaceous material is added to a solution containing a hydrophobic polymer, and then, the solution is stirred homogenously to provide the desired mixture containing the hydrophobic polymer and the carbonaceous material.

Subsequently, the mixture containing the hydrophobic polymer and the carbonaceous material is applied onto at least one surface of the carbonized substrate using any appropriate manner. For example, the manner may be selected from a group consisting of spraying, screen printing, coating, immersing, and combinations thereof. The amount of the mixture applied depends on a number of factors, such as the applying manner, the kind and area of the carbonized substrate, the desired thickness of the leveling layer, and the content of the solid in the mixture. For example, as compared with the carbon paper, the carbon cloth has a higher degree of roughness, so a larger amount of the mixture will be needed. Generally, the mixture is applied onto the carbonized substrate in an amount ranging from about 0.1 mg to 40 mg per cm² of the carbonized substrate. Optionally, the mixture may be applied onto both surfaces of the carbonized substrate, such that both surfaces thereof will have an improved property to further enhance the water management ability of the carbonized substrate and the fuel cell performance. When applied onto both surfaces of the carbonized substrate, the mixture is also applied in the amount described above, i.e., 0.1 mg/cm² to 40 mg/cm².

Thereafter, the carbonized substrate applied with the carbonaceous material and the hydrophobic polymer is subjected to a thermal treatment under the protection of an inert gas, to sinter the mixture into the leveling layer on the substrate. The temperature of the heat treatment is typically controlled to be higher than the melting point of the hydrophobic polymer, and preferably ranges from about 200° C. to about 450° C., and more preferably from about 250° C. to about 400° C. The duration of the heat treatment, which is not critical to the subject invention generally ranges from about 5 minutes to about 120 minutes, preferably from about 10 minutes to about 90 minutes, and more preferably from about 20 minutes to about 50 minutes. The inert gas suitable for the heat treatment of the subject invention may be selected from a group consisting of nitrogen, helium, argon, and combinations thereof. The most cost-effective option is nitrogen. By performing the heat treatment under the protection of an inert gas, the loss in the weight of the carbonaceous material due to the oxidation may be reduced, thus avoiding degradation to the conductive performance of the resulting modified carbonized substrate.

Through the heat treatment, the hydrophobic polymer forms a netlike structure with small pores. Such a structure is favorable for gas to flow therethrough, and due to the hydrophobic property thereof, also favorable for draining excessive water.

In accordance with the subject invention, a drying step is preferably performed prior to the heat treatment step to remove the excessive moisture and/or solvent in the mixture. For example, a natural drying method or a forced drying method may be adopted to remove the excessive moisture and/or solvent in the mixture. The natural drying method involves the direct placement of the carbonized substrate applied with the mixture in room temperature. The forced drying method involves placing the carbonized substrate in an oven at a temperature of 70° C. to 150° C. or drying it with the assistance of hot air.

In accordance with the method of the subject invention, to improve the fuel cell performance of the resulting carbonized substrate, the mixture applying step and the optional drying step may be recycled for 1 to 10 times. Subsequently, the heat treatment process is carried out under the protection of an inert gas.

The inventors of the subject application have found that by not using a pretreatment with the hydrophobic polymer on the carbonized substrate as in the prior art, the carbonized substrate can have the desired hydrophobic property by directly applying a mixture containing a hydrophobic polymer and a carbonaceous material onto the carbonized substrate. This may simplify the whole modifying process of the carbonized substrate and reduce the preparation cost. Meanwhile, the modified carbonized substrate prepared by the modifying method of the subject invention can still exhibit the desired conductivity and air permeability.

The subject invention further provides a modified carbonized substrate comprising a carbonized substrate and a leveling layer, in which the leveling layer is substantially directly disposed on at least one surface of the carbonized substrate. Herein, the phrase “the leveling layer is substantially directly disposed on at least one surface of the carbonized substrate” means that no separate hydrophobic layer formed by a pre-treatment as in the prior art exists between the carbonized substrate and the leveling layer. The using conditions of the carbonized substrate, the hydrophobic polymer and the carbonaceous material are as described above, and will not be described again herein.

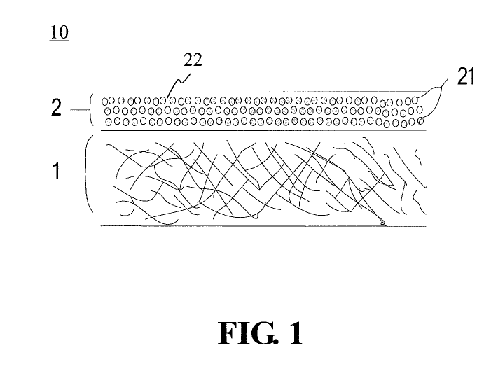

FIG. 1 depicts a schematic view of an embodiment of a modified carbonized substrate of the subject invention. The modified carbonized substrate 10 comprises a carbonized substrate 1 and a leveling layer 2 coated on the surface thereof The leveling layer 2 comprises a carbonaceous material 21 and a hydrophobic polymer 22 in which the hydrophobic polymer 22 will exhibit a netlike structure (not shown in the figure for the simplicity purpose) with small pores after being subjected to a heat treatment. Here, as described above, the leveling layer 2 may be optionally provided on both surfaces of the carbonized substrate 1.

The modified carbonized substrate of the subject invention does not only maintain the conductivity of the carbonized substrate due to the carbonaceous material contained in the leveling layer, but also exhibits the desired air permeability and an inherent hydrophobic property due to the thermally treated hydrophobic polymer (which forms a netlike structure having small pores). Therefore, the modified carbonized substrate is particularly suitable for use as a material for an electrode gas diffusion layer in a fuel cell.

Hence, the subject invention further provides a fuel cell comprising an anode and a cathode, especially a PEMFC or a DMFC fuel cell, which is characterized in that at least either the anode or the cathode comprises the modified carbonized substrate of the subject invention. As described in the descriptions of the related art, the materials and structures of various elements in a fuel cell are well-known to those having ordinary skill in the art. For example, the disclosures in Taiwan Patent Publication No. I272739 and U.S. Application Publication No. 2007/0117005A1 are incorporated herein by reference.

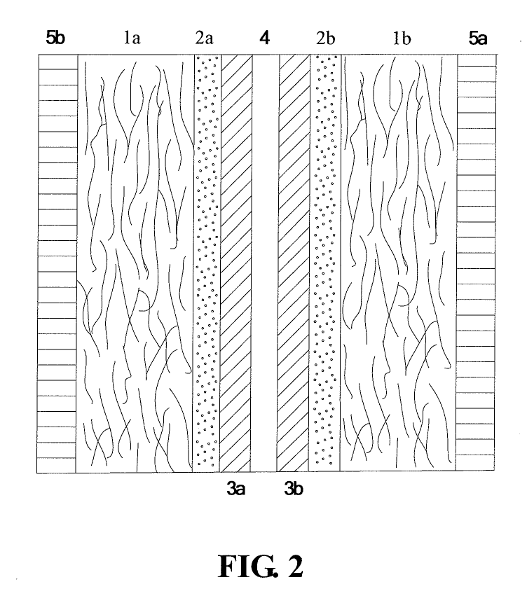

FIG. 2 illustrates the primary members in a single PEMFC cell of the subject invention. The primary members include a membrane electrode assembly (MEA) and bipolar plates 5a, 5b with gas flow channels. The MEA consists of a proton exchange membrane 4, catalyst layers 3a, 3b disposed on both surfaces of the proton exchange membrane 4, and carbonized substrates 1a, 1b disposed on the exterior surfaces of the catalyst layers 3a, 3b, respectively. The carbonized substrates 1a, 1b respectively have leveling layers 2a, 2b on the surface facing towards the respective catalyst layers 3a, 3b. The proton exchange membrane 4 may use the products of the Nafion series from Dupont, and the catalyst layers 3a, 3b may be Pd or Pt catalyst. Here, the carbonized substrates 1a, 1b coated with the leveling layers 2a, 2b on both surfaces may also be used in the MEA of the fuel cell. As manifested by the following examples in the subject application, a fuel cell containing the modified carbonized substrate of the subject invention demonstrates a superior fuel cell performance (e.g., current density).

The following examples will be hereby exemplified to further illustrate the subject invention. The measurement instruments and methods are described as follows:

### (A) Measurement Method of Gas Permeability

Measurement instrument: Gurley Model 4110, U.S.A

Capacity of the barrel for gas permeability measurement: 300 cc

Weight of the barrel for gas permeability measurement: 5 oz

Area measured: 1 sq. in

A sample piece was cut into a size of 10 cm×10 cm, and was tested according to ASTM D726-58.

### (B) Measurement Method of Contact Angle

Measurement instrument: GBX model D-S Instruments, France

The wettability is typically evaluated by the contact angle, which refers to the included angle θ formed between the tangent at a contact point of a liquid drop on a solid substrate surface and the solid-liquid interface. A smaller contact angle represents a better wettability, and vice versa. Generally, if 0°<θ<90°, the solid substrate surface is classified as hydrophilic; if θ>90°, the solid substrate surface is classified as hydrophobic; and if θ=0°, the solid substrate surface is classified to be completely wet.

The contact angle is calculated according to the following Young's Contact Angle equation:

θ₁ᵥ cos θ=θₛᵥ−θₛ₁,

wherein θ₁ᵥ represents the liquid phase-gas phase angle, θₛᵥ represents the solid phase-gas phase angle, and θₛ₁ represents the solid phase-liquid phase angle.

### (C) Measurement Method of Cell Performance

Testing machine: FCED® PD50 Asia Pacific Fuel Cell Technologies, Ltd.

Model of the cell load: Chroma 63103

Test Conditions:
Anode fuel: hydrogen (99.999%) at a flow rate of 200 c.c./min
Cathode fuel: oxygen (industrial level) at a flow rate of 200 c.c./min
Humidified temperature of the anode/cathode: 40° C.
Relative humidity at the humidifier outlet: 90%
Testing temperature: 40° C.
Assembling torque of the cell: 40 kgf·cm
Cell reaction area: 25 cm²

A thermally treated sample piece was cut into a size of 5 cm×5 cm, and was assembled with a catalyst-coated membrane (manufactured by Gore Corp., U.S.A, Model: PRIMEA® Series 5621 MESGA, 35 μm in thickness and made of 45 Pt alloy/60 Pt) by a 40 kgf·cm assembling torque. The bipolar plate was a graphite plate with gate-type channels thereon. Finally, a stainless steel plate and a Teflon gasket were used to encapsulate a single cell for testing purposes.

### (D) Measurement Method of the Surface Resistance

Testing machine: Loresta GP Model MCP-T600, Mitubishi Chemical Corp.

The sample piece was cut into a size of 5 cm×5 cm, and the test was performed according to JIS K 7194.

### EXAMPLE 1

A piece of carbon paper, prepared by the method described in U.S. Application Publication No. 2006/0214320, was carbonized at 1300° C. for 5 minutes under the protection of nitrogen. The resulting carbon paper was measured to have a thickness of 550 μm and a specific weight of 125 g/m².

Four g of Vulcan XC-72 (Cabot Corp., Boston Mass.) and FEP with a concentration of 10% (obtained by diluting 10 ml FEP 121A solution from Du Pont with 90 ml deionized water) were mixed homogenously and stirred continuously at room temperature for 5 minutes to obtain a liquid slurry.

The carbon paper was put on a flat solid surface, and the resulting slurry was sprayed onto the surface of the carbon paper. Afterwards, the sprayed carbon paper was put into an oven at 70° C. to be dried for 15 minutes, and then was subjected to a heat treatment at 350° C. under the protection of nitrogen to obtain a modified carbon paper.

The above measurement methods were carried out. In the cell performance measurement, the resulting modified carbon paper was used in the anode and cathode. The properties measured are listed in Table 1.

### EXAMPLE 2

The same raw materials and steps described in Example 1 were used, except that the spraying and drying steps were recycled 5 times. The above measurement methods were carried out. In the cell performance measurement, the resulting modified carbon paper was used in the anode and cathode. The properties measured are listed in Table 1.

### EXAMPLE 3

The same raw materials and steps described in Example 1 were used, except that the spraying and drying steps were recycled 10 times. The above measurement methods were carried out. In the cell performance measurement, the resulting modified carbon paper was used in the anode and cathode. The properties measured are listed in Table 1.

### COMPARISON EXAMPLE 1

The same raw materials and steps described in Example 1 were used, except that prior to the spraying, drying and heat treatment steps of Example 1, the carbon paper was first immersed into an FEP solution with a concentration of 3% (obtained by diluting 3 ml FEP 121A solution from Du Pont with 97 ml deionized water) and dried at 70° C. for 15 minutes. The above measurement methods were carried out. In the cell performance measurement, the resulting modified carbon paper was used in the anode and cathode. The properties measured are listed in Table 1.

TABLE 1

| | | | | | Surface resistance | | | |
|---|---|---|---|---|---|---|---|---|
| | | Contact angle | | Air | (Ω/sq) | | Current density | |
| | Thickness | Sprayed | Opposite | permeability | Sprayed | Opposite | (mA/cm²) | Loading |
| Example | (μm) | surface | surface | (sec/300 ml) | surface | surface | (below 0.5 V) | (mg/cm²) |
| 1 | 580 | >160 | 126.7 | 0.65 | 1.031 | 0.960 | 916 | 0.66 |
| 2 | 630 | >160 | — | 1.5 | 0.784 | 0.719 | 1059 | 5.35 |
| 3 | 680 | >160 | — | 4.7 | 0.864 | 0.824 | 994 | 10.45 |
| Comparison | 640 | | | 0.65 | 0.755 | 0.722 | 784 | 4.72 |
| example 1 | | | | | | | | |

As shown in Table 1, the modified carbon paper provided by the subject invention without any hydrophobic pre-treatment still had the desired hydrophobic property, which may be manifested by the fact that the contact angle of its sprayed surface was greater than 90°. Additionally, as compared with Comparison Example 1, when applied to a fuel cell, the modified carbon paper (Example 1) of the subject invention without any hydrophobic pre-treatment exhibited a higher current density (increased by 17%). Furthermore, as shown in Examples 2 and 3, a moderate performance improvement of the fuel cell was achieved by repeating the spraying and drying steps multiple times.

### EXAMPLE 4

A piece of commercially available carbon cloth (from CHALLENGE CARBON TECHNOLOGY CO., LTD., Model: FCW1005) was subjected to a heat treatment at 1750° C. for 5 minutes under the protection of nitrogen.

Two g of Vulcan XC-72 (Cabot Corp., Boston Mass.), 2 g of N660 (Korea Steel Chemical Co., Ltd) and FEP with a concentration of 10% (obtained by diluting 10 ml FEP 121A solution from Du Pont with 90 ml deionized water) were mixed homogenously and stirred continuously at room temperature for 5 minutes to obtain a liquid slurry.

The carbon cloth was put on a flat solid surface, and the resulting slurry was sprayed onto the surface of the carbon cloth. Afterwards, the sprayed carbon cloth was put into an oven at 70° C. to be dried for 15 minutes, and then was subjected to a heat treatment at 350° C. under the protection of nitrogen to obtain a modified carbon cloth.

The above measurement methods were carried out. In the cell performance measurement, the resulting modified carbon cloth was used in the anode and cathode. The properties measured are listed in Table 2.

### COMPARISON EXAMPLE 2

The same raw materials and steps described in Example 4 were used, except that prior to the spraying, drying and heat treatment steps of Example 4, the carbon cloth was first immersed into an FEP solution with a concentration of 3% (obtained by diluting 3 ml FEP 121A solution from Du Pont with 97 ml deionized water) and dried at 70° C. for 15 minutes. The above measurement methods were carried out. In the cell performance measurement, the resulting modified carbon cloth was used in the anode and cathode. The properties measured are listed in Table 2.

### COMPARISON EXAMPLE 3

A piece of carbon cloth identical to that of Example 4 was subjected to a heat treatment at 1750° C. for 5 minutes under the protection of nitrogen. Next, the carbon cloth was immersed into an FEP solution with a concentration of 3% (obtained by diluting 3 ml FEP 121A solution from Du Pont with 97 ml deionized water) and dried at 70° C. for 15 minutes.

The spraying and drying processes described in Example 4 were performed, followed by a heat treatment at 350° C. under atmospherical conditions to obtain a modified carbon cloth.

The above measurement methods were carried out. In the cell performance measurement, the resulting modified carbon cloth was used in the anode and cathode. The properties measured are listed in Table 2.

### COMPARISON EXAMPLE 4

The same raw materials and steps described in Example 4 were used, except that the heat treatment step was performed under atmospherical conditions. The above measurement methods were carried out. In the cell performance measurement, the resulting modified carbon cloth was used in the anode and cathode. The properties measured are listed in Table 2.

TABLE 2

| | | | | | Surface resistance | | | | Weight loss |
|---|---|---|---|---|---|---|---|---|---|
| | | Contact angle | | Air | (Ω/sq) | | Current density | | during |
| | Thickness | Sprayed | Opposite | permeability | Sprayed | Opposite | (mA/cm²) | Loading | sintering |
| | (μm) | surface | surface | (sec/300 ml) | surface | surface | (below 0.5 V) | (mg/cm²) | (wt %) |
| Example 4 | 620 | >160 | >160 | 1 | 0.382 | 0.427 | 1248 | 3.09 | 0.76 |
| Comparison | 620 | >160 | >160 | 1 | 0.39 | 0.401 | 1131 | 2.27 | 0.55 |
| example 2 | | | | | | | | | |
| Comparison | 590 | | | 2 | 0.421 | 0.528 | 1127 | 3.2 | 1.84 |
| example 3 | | | | | | | | | |
| Comparison | 570 | | | 2.4 | 0.413 | 0.432 | 1088 | 3.16 | 1.60 |
| example 4 | | | | | | | | | |

It can be seen from Table 2 that, as compared with Comparison Examples 2 to 4, the modified carbon cloth of the subject invention (Example 4) exhibited a considerable hydrophobic property, and when applied in a fuel cell, showed a better cell performance. Additionally, the modified carbon cloth suffered a weight loss up to 1.84 wt % (Comparison Example 3) and 1.60 wt % (Comparison Example 4) during the heat treatment under atmospherical conditions, which were higher than that suffered during the heat treatment under the protection of nitrogen (Example 4, 0.76 wt %).

### EXAMPLE 5

A piece of commercially available carbon paper TGP-H-090 (from Toray Corp.) was used.

Two g of Vulcan XC-72 (Cabot Corp., Boston Mass.), 2 g of N660 (Korea Steel Chemical Co., Ltd), and FEP with a concentration of 10% (obtained by diluting 10 ml FEP 121A solution from Du Pont with 90 ml deionized water) were mixed homogenously and stirred continuously at room temperature for 5 minutes to obtain a liquid slurry.

The carbon paper was put on a flat solid surface, and the resulting slurry was sprayed onto the surface of the carbon paper. Afterwards, the sprayed carbon paper was put into an oven at 70° C. to be dried for 15 minutes, and then was subjected to a heat treatment at 350° C. under the protection of nitrogen to obtain a modified carbon paper.

The above measurement methods were carried out. In the cell performance measurement, the resulting modified carbon paper was used in the anode and cathode. The properties measured are listed in Table 3.

### COMPARISON EXAMPLE 5

The same raw materials and steps described in Example 5 were used, except that prior to the spraying, drying and heat treatment steps of Example 5, the carbon paper was first immersed into an FEP solution with a concentration of 3% (obtained by diluting 3 ml FEP 121A solution from Du Pont with 97 ml deionized water) and dried at 70° C. for 15 minutes. The above measurement methods were carried out. In the cell performance measurement, the resulting modified carbonized cloth was used in the anode and cathode. The properties measured are listed in Table 3.

TABLE 3

| | | | | | Surface resistance | | | |
|---|---|---|---|---|---|---|---|---|
| | | Contact angle | | | (Ω/sq) | | Current density | |
| | Thickness | Sprayed | Opposite | Air permeability | Sprayed | Opposite | (mA/cm²) | Loading |
| | (μm) | surface | surface | (sec/300 ml) | surface | surface | (below 0.5 V) | (mg/cm²) |
| Example 5 | 330 | >160 | 142.6 | 2 | 0.209 | 0.199 | 527 | 1.89 |
| Comparison | 330 | >160 | >160 | 2.1 | 0.207 | 0.199 | 431 | 2.12 |
| Example 5 | | | | | | | | |

It can be seen from Table 3 that, as compared with Comparison Example 5, the modified carbon paper of the subject invention (Example 5) without any hydrophobic pretreatment exhibited a considerable hydrophobic property, and when applied in a fuel cell, showed a higher current density (increased by 22%).

### EXAMPLE 6

A piece of commercially available carbon cloth (from CHALLENGE CARBON TECHNOLOGY CO., LTD., Model: FCW1005) was subjected to a heat treatment at 1750° C. for 5 minutes under the protection of nitrogen.

Two g of Vulcan XC-72 (Cabot Corp., Boston Mass.), 2 g of N660 (Korea Steel Chemical Co., Ltd) and FEP with a concentration of 10% (obtained by diluting 10 ml FEP 121A solution from Du Pont with 90 ml deionized water) were mixed homogenously and stirred continuously at room temperature for 5 minutes to obtain a liquid slurry.

The carbon cloth was put on a flat solid surface, and the resulting slurry was sprayed onto the surface of the carbon cloth. Afterwards, the sprayed carbon cloth was put into an oven at 70° C. to be dried for 15 minutes. Furthermore, the slurry was also sprayed onto the other surface of the carbon cloth, and the sprayed carbon cloth was again put into the oven at 70° C. to be dried for another 15 minutes. Then, a heat treatment at 350° C. under the protection of nitrogen was performed to obtain a modified carbon cloth.

The above measurement methods were carried out. In the cell performance measurement, the resulting modified carbon cloth was used in the cathode and that obtained in Example 4 was used in the anode. The properties measured are listed in Table 4.

### EXAMPLE 7

The same raw materials and steps described in Example 6 were used to obtain a modified carbon cloth. The above measurement methods were carried out. In the cell performance measurement, the resulting modified carbon cloth was used in the anode and that obtained in Example 4 was used in the cathode. The properties measured are listed in Table 4.

### EXAMPLE 8

The same raw materials and steps described in Example 6 were used to obtain a modified carbon cloth. The above measurement methods were carried out. In the cell performance measurement, the resulting modified carbonized cloth was used in the anode and cathode. The properties measured are listed in Table 4.

TABLE 4

| | Current density of the |
|---|---|
| | fuel cell (at a voltage below 0.5 V) (mA/cm²) |
| Example 6 | 1008 |
| Example 7 | 1099 |
| Example 8 | 1110 |

It can be seen from Table 4 that it did not matter whether the carbonized substrate was modified on a single surface or on both surfaces, and whether the resulting modified carbonized substrate was used in the anode or the cathode of a fuel cell. A better fuel cell performance was still attained.

The above examples are intended to illustrate the embodiments of the subject invention and its technical features, but not to limit the scope of protection of the subject invention. Any modifications that can be easily accomplished by persons skilled in the art or equivalent replacements are within the scope of the subject invention. The scope of protection of the subject invention should be based on the claims as appended.

What is claimed is:

1. A method for modifying a carbonized substrate, comprising:
providing a carbonized substrate;
providing a mixture containing a hydrophobic polymer and a carbonaceous material;
applying the mixture onto at least one surface of the carbonized substrate; and
thermally treating the carbonized substrate under the protection of an inert gas.

2. The method according to claim 1, wherein the carbonized substrate is selected from a group consisting of carbon cloth, carbon paper, and carbon felt.

3. The method according to claim 1, wherein the hydrophobic polymer is selected from a group consisting of polytetrafluoroethylene (PTEF), polyhexafluoropropylene (PHFP), copolymers of hexafluoropropylene and tetrafluoroethylene (FEP), copolymers of tetrafluoroethylene and perfluoropropylvinylether (PFA), copolymers of tetrafluoroethylene and perfluoromethylvinylether (MFA), homopolymers of chlorotrifluoroethylene (PCTFE), polyvinylidene fluoride (PVDF), poly(vinylfluoride) (PVF), copolymer of tetrafluoroethylene and ethylene (ETFT), copolymer of vinylidene fluoride and hexafluoropropylene and tetrafluoroethylene (THV), and combinations thereof.

4. The method according to claim 1, wherein the carbonaceous material comprises a powdered carbonaceous material, a fibrous carbonaceous material, or a combination thereof.

5. The method according to claim 1, wherein the carbonaceous material is selected from a group consisting of carbon black, graphite, acetylene black, and combinations thereof.

6. The method according to claim 1, wherein the applying step is performed by a manner selected from a group consisting of spraying, screen printing, coating, immersing, and combinations thereof.

7. The method according to claim 1, wherein the mixture is applied onto the both surfaces of the carbonized substrate.

8. The method according to claim 1, further comprising a drying step before the thermal treatment step.

9. The method according to claim 8, wherein the drying step is performed at a temperature ranging from about 70° C. to about 150° C.

10. The method according to claim 8, wherein the applying step and the drying step are recycled for 1 to 10 times.

11. The method according to claim 1, wherein the inert gas is selected from a group consisting of nitrogen, helium, argon, and combinations thereof.

12. The method according to claim 1, wherein the temperature of the thermal treatment is higher than the melting point of the hydrophobic polymer.

13. The method according to claim 12, wherein the thermal treatment is performed at a temperature ranging from about 200° C. to about 450° C. for about 5 minutes to about 120 hours.

14. A modified carbonized substrate, comprising:
a carbonized substrate; and
a leveling layer substantially directly disposed on at least one surface of the carbonized substrate.

15. The modified carbonized substrate according to claim 14, wherein the carbonized substrate is selected from a group consisting of carbon cloth, carbon paper, and carbon felt.

16. The modified carbonized substrate according to claim 14, wherein the leveling layer comprises a hydrophobic polymer and a carbonaceous material.

17. The modified carbonized substrate according claim 16, wherein the hydrophobic polymer is selected from a group consisting of PTFE, PHFP, FEP, PFA, MFA, PCTFE, PVDF, PVF, ETFT, THV, and combinations thereof.

18. The modified carbonized substrate according to claim 16, wherein the carbonaceous material comprises a powdered carbonaceous material, a fibrous carbonaceous material, or a combination thereof.

19. The modified carbonized substrate according to claim 16, wherein the carbonaceous material is selected from a group consisting of carbon black, graphite, acetylene black, and combinations thereof.

20. The modified carbonized substrate according to claim 14, for use in a gas diffusion layer of an electrode in a fuel cell.

21. A fuel cell comprising an anode and a cathode, wherein at least either the anode or the cathode comprises the modified carbonized substrate according to claim 14.
